(19) United States
(12) Patent Application Publication
(10) Pub. No.: US 2005/0141711 A1
(43) Pub. Date: Jun. 30, 2005

(54) Data recording medium, data recording apparatus, data recording method, data reproduction method and data transmission apparatus

(76) Inventors: Akiko Inoue, Saitama (JP); Yoichiro Sako, Tokyo (JP); Shunsuke Furukawa, Tokyo (JP); Yoriaki Kanada, Kanagawa (JP); Koichi Nakajima, Chiba (JP); Akiya Saito, Kanagawa (JP); Etsuo Shibasaki, Tokyo (JP); Kaoru Kijima, Tokyo (JP)

Correspondence Address: William E. Vaughan;Bell, Boyd & Lloyd LLC, P.O. Box 1135, Chicago, IL, 60690, US

(21) Appl. No.: 10/933,884

(22) Filed: Sep. 3, 2004

(30) Foreign Application Priority Data
Sep. 5, 2003 (JP) P2003-314314

(51) Int. Cl. H04N 7/167

(52) U.S. Cl. 380/228

(57) ABSTRACT

A data recording medium on which digital data is recorded eliminates acquisition by a user of a plurality of data recording media for different applications to improve the convenience is provided. Digital data for a plurality of different applications and UIDs as identification information added for the individual applications are recorded on the same data recording medium. For example, a music CD on which data for promotion and data for a normal version are managed with different UIDs from each other is distributed as a CD for promotion. The data for promotion allow free reproduction thereof. If a user tries the music CD and wants to purchase the data for a normal version, then the user would access a server owned or managed by a record company of a distributor of the music CD to perform a charging procedure. This validates the UID with which the data for a normal version is managed, and after the UID is authenticated by the server, reproduction of the full data is permitted.

### CROSS REFERENCE TO RELATED APPLICATIONS

This application claims priority to Japanese Patent Application No. P2003-314314, filed on Sep. 5, 2003, the disclosure of which is incorporated by reference herein.

### BACKGROUND OF THE INVENTION

The present invention relates to a data recording medium on which identification information is recorded individually for data used for a plurality of different applications, a data recording apparatus and a data recording method for recording such identification information, a data reproduction method for reproducing the data recording medium and a data transmission apparatus which transmits and receives data including such identification information.

A compact disc (CD) is used widely as a disc type recording medium wherein audio data of a music program or the like as a literary work is recorded in the form of digital data and can be read out by means of an optical reproduction apparatus.

Meanwhile, a digital versatile disc (DVD) is provided as a data recording medium on which image information or the like of a high picture quality is recorded in the form of digital data.

Digital data based on various contents is recorded on such a CD or a DVD as described above. The substance of recorded contents of a CD or a DVD can be known to a user by such a method as, for example, listening to a promotion CD or recognizing the existence of a CD or a DVD through an advertisement medium of a television, a radio, a newspaper, the Internet or the like.

It is to be noted that such data recording media as a CD and a DVD can be copied and distributed in large numbers, and it is being popularized at present to record, in order to identify each of such data recording media, an individual ID (Unique Identification: hereinafter referred to as UID) on each medium in advance as disclosed, for example, in Japanese Patent Laid-Open No. 2002-319245.

However, conventionally, in promotion discs for music and so forth, for example, since a promotion disc and a normal disc which includes a subtitle are provided separately from each other, even if a user gets the promotion disc previewed and is satisfied with the substance of it, in order to purchase the normal disc, the user must go to buy it or must order through the internet or the like. Thus, much time is required for the user to acquire the normal disc.

Further, although a data recording medium having a UID for identification of the data recording medium is conventionally available, no available data recording medium has a plurality of UIDs for different applications.

### SUMMARY OF THE INVENTION

The present invention provides a data recording medium, a data recording apparatus, a data recording method, a data reproduction apparatus and a data transmission apparatus by which digital data for a plurality of applications and pieces of identification information added for the individual applications is recorded on the same data recording medium to improve the convenience in that a user need not acquire a plurality of data recording media for different applications.

In an embodiment of the present invention, there is provided a data recording medium on which digital data is recorded, the data recording medium having a plurality of pieces of identification, which relate individually to digital data used for a plurality of different applications, recorded in advance thereon.

A data recording medium on which data based on a plurality of contents such as, for example, a plurality of literary work data is recorded is conventionally available. However, a data recording medium on which data to be used for a plurality of different applications such as, for example, data which allow free auditioning and data which can be used only after an equivalent is paid is recorded is not conventionally available. Thus, the conventional data recording medium does not allow use thereof for the plurality of applications.

With the data recording medium of the present invention, a plurality of data to be used for different applications and identification information corresponding to the data can be recorded on the same data recording medium, and use of the data for the different applications can be performed with the same data recording medium.

In particular, with the data recording medium of the present invention, since data for a plurality of applications and identification information corresponding to the data is recorded on one data recording medium, the necessity to acquire a plurality of data recording media in accordance with the applications is eliminated. For example, after a music CD for promotion is auditioned, a CD for a normal version can be acquired as the data recording medium at the place.

Therefore, although it is conventionally necessary to go to a shop or give an order by a telephone or through the internet to acquire a music CD for a normal version when a user auditions a music CD for promotion and finds it favorable, the data recording medium of the present invention eliminates the necessity and is very high in convenience.

Further, the data recording medium of the present invention can raise value in utilization and an expanded utilization form. Conventionally, for example, a data recording medium for promotion is utilized only for promotion, and where a data recording medium for a normal version is purchased, two data recording media are involved. However, with the data recording medium of the present invention, since it has, for example, data for promotion and data for a normal version as well as identification information corresponding to them recorded thereon, only if the identification information is used to validate the data for a normal version, then the data for a normal version can be purchased. Consequently, only one data recording medium is involved.

According to another embodiment of the present invention, there is provided a data recording apparatus for recording digital data on a data recording medium, wherein the data recording apparatus records, upon manufacture of a data recording medium, a plurality of pieces of identification information individually relating to digital data to be used for a plurality of different applications on the data recording medium.

According to a further embodiment of the present invention, there is provided a data recording method for recording digital data on a data recording medium, including recording, upon manufacture of a data recording medium, a plurality of pieces of identification information individually relating to digital data to be used for a plurality of different applications on the data recording medium.

With the data recording apparatus and the data recording method, since data used for a plurality of applications and a plurality of pieces of identification information individually relating to the data is recorded readily on the same data recording medium upon manufacture of a data recording medium, a large number of data recording media can be manufactured at a time and distributed.

Consequently, the possibility that, for example, a record company on a server side may acquire a very large market promotes, and the business opportunities can be enlarged.

Further, since the necessity, for example, for the record company of the server side to possess a large number of data recording media of commodities as a stock of the record company itself is eliminated, the space for inventory of such media is significantly reduced or to zero. Further, a conventional risk in that a large number of commodities are stocked and the distribution of them is controlled is eliminated.

According to a still further embodiment of the present invention, there is provided a data reproduction method for reproducing a recording medium on which digital data to be used for a first application and first identification information relating to the digital data as well as digital data to be used for a second application and second identification information relating to the digital data for the second application is recorded, including discriminating whether or not identification information is recorded on the recording medium, discriminating, when the identification information is recorded on the recording medium, whether the recorded identification information is the first identification information or the second identification information, and reproducing, when it is discriminated that the recorded identification information is the first identification information, the digital data relating to the first identification information, but decrypting, when it is discriminated that the recorded identification information is the second identification information, the digital data relating to the second identification information based on data relating to a key for decryption of the digital data acquired from outside and reproducing the decrypted digital data.

According to a yet further embodiment of the present invention, there is provided a data transmission apparatus, including a terminal section for reproducing a recording medium on which digital data to be used for a first application and first identification information relating to the digital data as well as digital data to be used for a second application and second identification information relating to the digital data for the second application are recorded, and a server section connected to the terminal section through a communication line for managing the recording medium, the server section being operable to discriminate, when the first identification information is received from the terminal section, the received first identification information and permit, when it is discriminated that the first identification information is identification information managed by the server section, a procedure for decoding the digital data relating to the second identification information.

The data transmission apparatus may be configured such that, when it is discriminated that the first identification information is identification information managed by the server section, or when the charging process is performed by the terminal section, the server section provides a predetermined service to the terminal section.

With the data transmission apparatus, various services such as, for example, to provide a concert ticket of the player of the literary work data or to provide the ticket by lottery can be provided based on the identification information written on the data recording medium. Consequently, such economical effects can be anticipated that the added value of the data recording medium increases and promotes the will of the user to purchase the data recording medium and that the reliability on or the popularity of, for example, a record company (contents production/distribution company) of the server side is promoted.

The data transmission apparatus may be configured such that the server section counts the number of times by which the first identification information is inputted thereto through the communication line or by which the charging process is performed by the terminal section.

With the data transmission apparatus, the server side can acquire, with certainty from the identification information written on the data recording medium, such information of, for example, at what rate a disc for a normal version is purchased with respect to a distributed disc for promotion, and can utilize the thus acquired information for the future marketing.

Additional features and advantages of the present invention are described in, and will be apparent from, the following Detailed Description of the Invention and the figures.

### BRIEF DESCRIPTION OF THE FIGURES

FIG. 1 is a schematic view showing a general configuration of a disc type recording medium according to an embodiment of the present invention.

FIGS. 2A to 2D are diagrammatic views illustrating an example of a configuration of a recording format of a UID data recorded on the disc type recording medium of FIG. 1.

FIGS. 3A to 3C are schematic views illustrating a recording form of a UID recorded on the disc type recoding medium of FIG. 1.

FIG. 4 is a block diagram showing a general configuration of a reproduction apparatus which is used for reproduction of the disc type recording medium of FIG. 1.

FIG. 5 is a flow chart illustrating a charging and authentication procedure according to an embodiment of the present invention.

FIG. 6 is a schematic view showing an example of a system for utilizing the disc type recording medium of FIG. 1.

FIG. 7 is a flow chart illustrating an example of a procedure for communication of data recorded on the disc type recording medium of FIG. 1.

FIG. 8 is a flow diagram illustrating an example of a procedure for manufacture of the disc type recording medium of FIG. 1.

FIGS. 9 and 10 are block diagrams showing different examples of an apparatus configuration as applied to a laminated disc and a UID is recorded on the laminated disc according to an embodiment of the present invention.

FIG. 11 is a sectional view showing an example of a configuration of a laminated disc according to an embodiment of the present invention.

FIG. 12 is a flow chart illustrating a procedure of manufacturing the disc of FIG. 11.

### DETAILED DESCRIPTION OF THE INVENTION

The present invention relates to a data recording medium on which identification information is recorded individually for data used for a plurality of different applications, a data recording apparatus and a data recording method for recording such identification information, a data reproduction method for reproducing the data recording medium and a data transmission apparatus which transmits and receives data including such identification information.

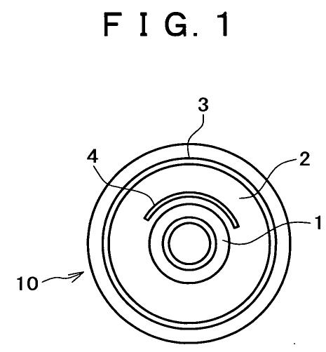

Referring first to FIG. 1, there is shown a disc type recording medium to which the present invention is applied in an embodiment. The disc type recording medium 10 shown has a lead-in region 1, a program area (data recording region) 2 and a lead-out region 3. The lead-in region 1 is provided on the inner circumference side of the disc type recording medium 10. The program area 2 is provided on the outer circumference side with respect to the lead-in region 1, and main data such as literary work data based on contents such as a tune, images and so forth are recorded in the program area 2. The lead-out region 3 is provided on the outer circumference side with respect to the program area 2.

The program area 2 includes a UID area 4 in which a plurality of pieces (UIDs) of identification information applied individually for different applications of main digital data such as literary work data. The identification information of the present invention is written, for example, in accordance with the PID system in the UID area 4 in the program area (data recording region) 2 or written in a determined format in the lead-in region 1.

The main digital data such as literary work data (digital data of the present invention) is recorded in a recording format conventionally used for a compact disc (CD) or a digital versatile disc (DVD), and the identification information (UID) of the present invention is recorded, for example, in a recording format different from the recording format of the digital data.

Where an optical disk for read only on which data is recorded based on a recording format of a CD or a DVD is to be produced, a large number of optical disks of the same type are manufactured using a stamper for transferring a concave and convex pattern corresponding to digital data to be recorded. Therefore, the identification information (UIDs) of the present invention is recorded by writing directly on a reflection film for each recording medium during a manufacturing process of recording media. A manufacturing method of a disc type recording medium on which the identification information (UIDs) is recorded is hereinafter described.

The main digital data mentioned above is a plurality of data having different applications, and, for example, literary work data based on contents of a music tune or images for promotion and literary work data based on contents of a music tune or images for a normal version are recorded as the main digital data.

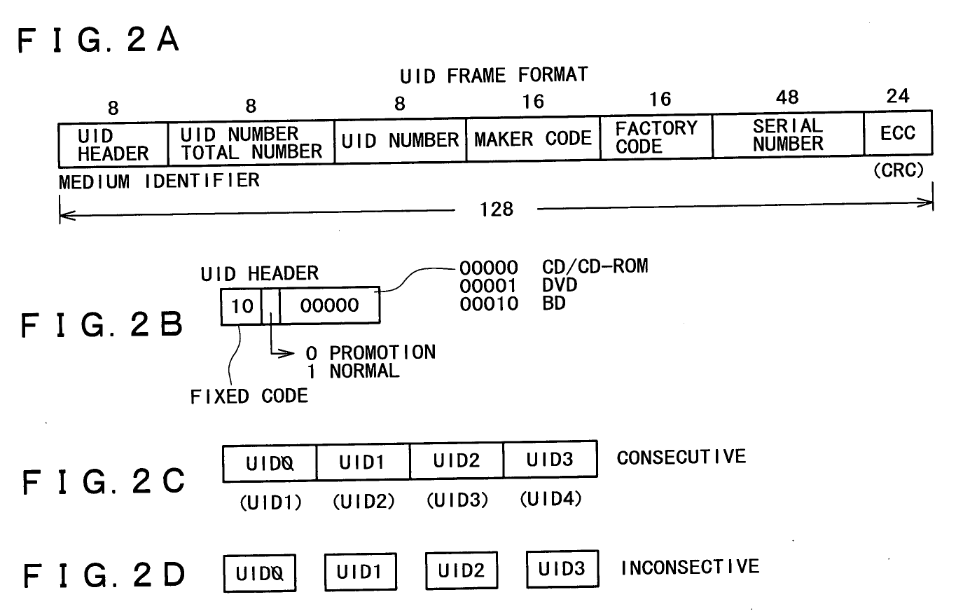

The identification information (UID) of the present invention is applied to each of the plurality of data having different applications, and an example of a recording format for the identification information is shown in FIGS. 2A to 2D. In FIG. 2A, for example, the top 8 bits form a UID header used as a medium identifier. The UID header includes, for example, as seen in FIG. 2B, a fixed code, an identification code for identification of the disc between a medium for promotion and a medium for a normal version, and a code representative of a type of a medium.

In a region next to the UID header, a UID number total number (for example, 8 bits) representative of how many UID numbers are included in the medium is disposed. In a region next to the UID number total number, information of a UID number (for example, 8 bits) representative of what numbered UID the UID is disposed.

In a region next to the UID number, a maker code (for example, 16 bits) of, for example, a record company or the like and a factory code (for example, 16 bits) are disposed. In a region following the factory code, information of, for example, a serial number of 48 bits is disposed.

The serial number is formed from a URL which is a connection address for connecting to a sever side which manages the medium hereinafter described (that is, to a source of distribution from which the literary work is supplied) through a communication line such as the Internet, information for connection to a portable telephone set or the like.

In a region following the serial number, an error correction code (ECC) of, for example, 24 bits is disposed. Thus, the UID recording format is formed from, for example, 128 bits as a whole.

The error correction code (ECC) includes a cyclic redundancy code (CRC) and is used to check and authenticate whether or not UID data is present, whether or not data is falsified and so forth.

The UID header, UID number total number and UID number are used as UID data presence/absence discrimination information. The UID number total number, UID number, manufacture code, factory code, and serial number are formed as an encryption area in which they are recorded in a form encrypted by data conversion.

For the encryption system, a public key system such as the Rivest, Shamir and Adleman (RSA) system or a common key system such as the Data Encryption Standard (DES) system or the Advanced Encryption Standard (AES) system is used.

It is to be noted that the format of UID data illustrated in FIGS. 2A and 2B indicates a mere example, and the number of bits for each region, the arrangement of the regions and so forth can be set arbitrarily and also the number of kinds of regions may be increased or decreased.

The encrypted UID data is decrypted by using data relating to a key for decryption acquired from the server side hereinafter described and permit reproduction of the literary work data (main digital data) corresponding to the UID.

A plurality of such UID digital data having the configuration described above may be recorded continuously at the same position as seen in FIG. 2C or may otherwise be recorded intermittently as seen in FIG. 2D.

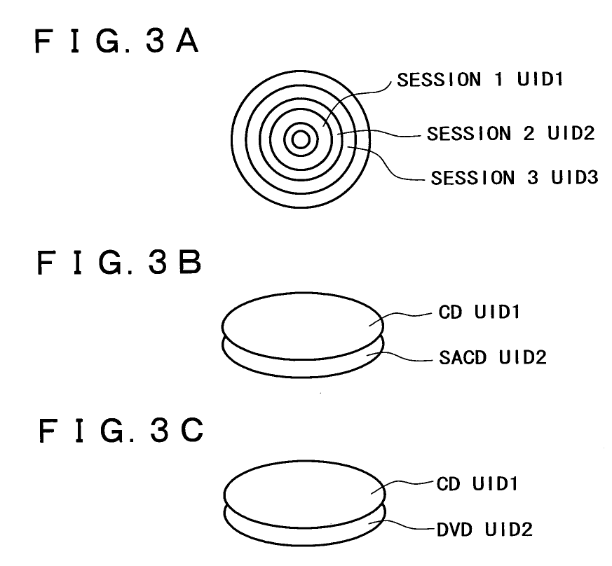

On the other hand, where contents exist for each session of a disc type recording medium, a plurality of such UID data as described above may be recorded individually in divided regions of the sessions as seen in FIG. 3A. However, where the recording medium is of the type illustrated in FIG. 3B wherein a CD and a SACD are adhered to each other or of the type illustrated in FIG. 3C wherein a CD and a DVD are adhered to each other, the UID data is recorded in two layers or on the opposite faces of the recording medium.

In other words, the UID data is recorded on each recording layer in any of a data recording medium wherein a plurality of recording layers are layered on one surface of the substrate, another data recording medium wherein recording layers each provided on one surface of each of two substrates are adhered to each other and a further data recording medium wherein, of recording layers each provided on one surface of each of two substrates, the recording layer of one of the two substrates and the other substrate are adhered to each other.

Now, a reproduction apparatus for reproducing the disc type recording medium 10 on which literary work data (main digital data) and corresponding UID data are recorded as illustrated in FIG. 1 is described.

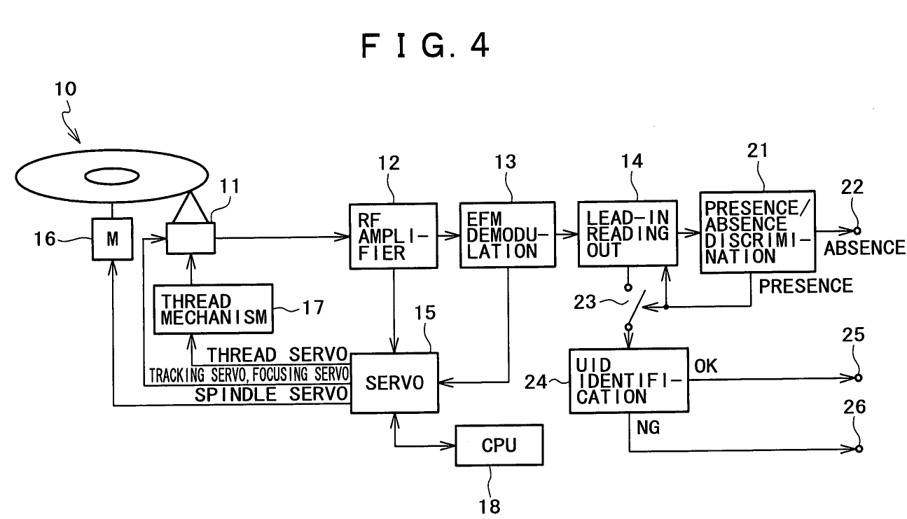

Referring to FIG. 4, the reproduction apparatus includes an optical head 11 for scanning the region, in which data is recorded, of the disc type recording medium 10 loaded in the reproduction apparatus and driven to rotate by a spindle motor 16 to read out the data recorded on the disc type recording medium 10.

The data recorded on the disc type recording medium 10 and read by the optical head 11 are supplied to an RF amplifier 12. A reproduction RF signal is outputted from the RF amplifier 12 and sent to and EFM demodulated by an EFM (8-14 modulation) demodulation circuit 13 and then sent to a lead-in reading out circuit 14. Also various servo signals such as a tracking error signal and a focusing error signal are outputted from the RF amplifier 12 while a reproduction clock signal and so forth are outputted from the EFM demodulation circuit 13, and the signals from the RF amplifier 12 and the EFM demodulation circuit 13 are supplied to a servo circuit 15. The servo circuit 15 outputs various servo signals such as a tracking servo signal and a focusing servo signal.

The spindle servo signal outputted from the servo circuit 15 is supplied to the spindle motor 16 for driving a disc to rotate while the tracking servo signal and the focusing servo signal are supplied to actuators of the optical head 11 to perform tracking servo and focusing servo. The thread servo signal is supplied to a thread driving motor of a thread mechanism 17 for moving the optical head 11 in a diametrical direction of the disc type recording medium. Control commands, control data and so forth are communicated between the servo circuit 15 and a CPU (processor unit) 18, for example, through a bus.

The lead-in reading out circuit 14 supplies data read out from the lead-in region 1 of the disc type recording medium 10 by the optical head 11 to a presence/absence discrimination circuit 21. The presence/absence discrimination circuit 21 discriminates whether or not the data read out from the lead-out region 3 include discrimination information (the UID header, UID number total number and UID number of FIG. 2A) representative of whether or not UID data exists.

If the presence/absence discrimination circuit 21 discriminates that the data read out from the lead-out region 3 does not include discrimination information, then the reproduction apparatus of FIG. 4 discriminates that the disc type recording medium loaded in the reproduction apparatus is a disc type recording medium on which only literary work data (main digital data) is recorded in accordance with a recording format based on the CD or DVD format. The reproduction apparatus thus performs reproduction of the data of the disc type recording medium loaded therein and outputs the reproduced data from an output terminal 22.

On the other hand, if the presence/absence discrimination circuit 21 discriminates that the data read out from the lead-out region 3 include discrimination information, then the reproduction apparatus supplies a control signal to the lead-in reading out circuit 14 so that the optical head 11 is moved to the innermost circumferential side of the disc type recording medium 10 to read out the information recorded in the lead-in region 1 and switches on a switch 23 for selecting a reproduction mode so that a signal including the UID data supplied from the lead-in reading out circuit 14 is supplied to a UID identification circuit 24.

While, in the present embodiment, it is presupposed that the UID data is recorded in the lead-out region 3, where such UID data is recorded in the program area 2 as in the disc type recording medium 10 shown in FIG. 1, the information recorded in the program area 2 is read out and sent to the UID identification circuit 24.

The UID identification circuit 24 discriminates whether or not the UID data is identified normally. If the read out UID data is recognized normally (OK) and decrypted using a key for decryption, reproduction of the literary work data (main digital data) corresponding to the UID data is performed, and the reproduced data is outputted from a first output terminal 25. If the UID data cannot be discriminated normally (NG), then a reproduction inhibition signal of the digital data is outputted from a second output terminal 26.

Now, an example of a form of utilization of the data recording medium to which the present invention is applied as described above is described. First, a data recording medium of the present invention wherein a plurality of UIDs are provided individually for different applications data and data for promotion and data for a normal version (normal version data) are individually managed with a plurality of UIDs different from each other is distributed as a data recording medium for promotion.

The data for promotion can be reproduced free of charge, and if a user gets the data for promotion previewed and wants to purchase the data for a normal version, then the user can access a server possessed or managed by a record company of a distribution source of the data recording medium to perform a charging procedure.

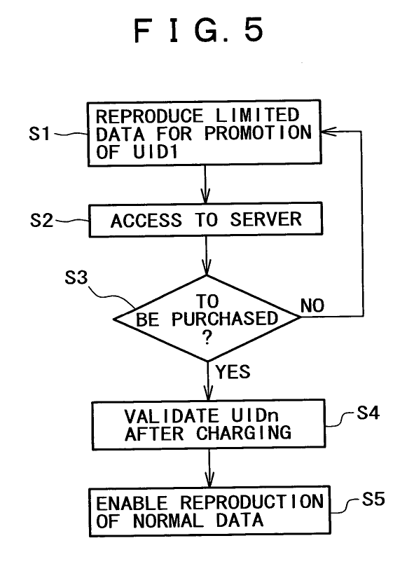

As the charging procedure is performed, the UID by which the data for a normal version is managed is validated, and after the UID is authenticated by the server, reproduction of the full data is enabled. The charging and authentication procedure is performed, for example, as at steps S1 to S5 of a flow chart of FIG. 5.

Refer to FIG. 5, the data of the UID1 restricted for the promotion is reproduced first at step S1. Then at step S2, the reproduction apparatus accesses a server. At step S3, it is discriminated whether or the data for a normal version should be purchased. If a result of the discrimination is NO, then the processing returns to step S1, but if the result of the discrimination is YES, then the UIDn data is validated after a charging process at step S4. Consequently, reproduction of the data for a normal version is enabled.

In the case of a music CD, a user can enjoy such a service that, where the UID for promotion is used, the user can only listen to one part of the music. However, after the charging process is performed, since a new UID is authenticated, the user can listen to all tunes. Or another service may be considered that different sound qualities are used or the number of tunes which the user can enjoy is different before and after the charging.

In the case of a DVD, for example, such a service may be used that, before charging, the user can enjoy only a monochrome image, but after charging, the user can see a color image.

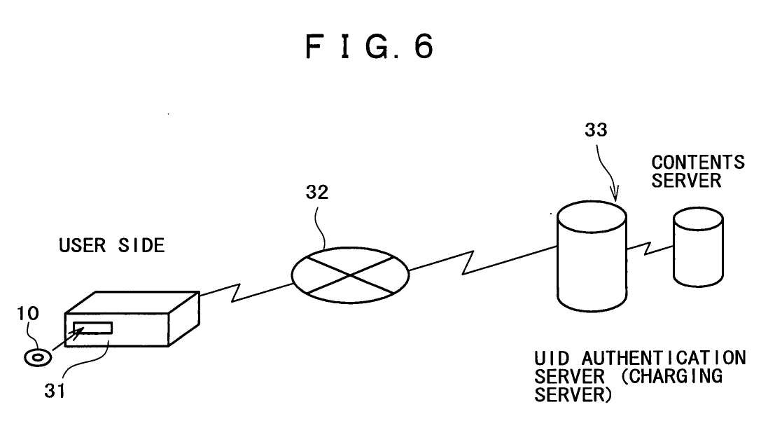

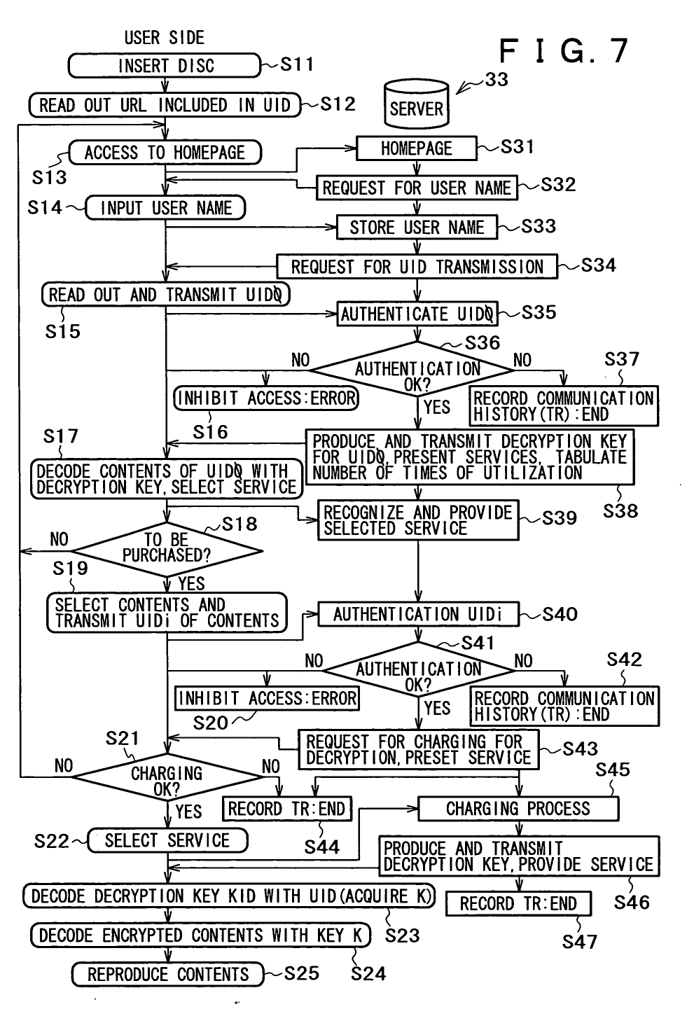

Referring now to FIG. 6, a system is shown in which the disc type recording medium to which the present invention is applied is utilized. The system shown includes a UID reproduction optical disk player 31 connected to a personal computer (not shown) having a communication function, a communication network or the Internet 32, and a server (UID authentication server, contents server) 33 owned or managed by a record company of a distribution source of the recording medium. The UID reproduction optical disk player 31 is used to read various data and information recorded on a disc type recording medium 10 to which the present invention is applied and communicates with the server 33 through the Internet 32. The procedure of operations of the UID reproduction optical disk player 31 and the Internet 32 in this instance is described below with reference to FIG. 7.

In the flow chart of FIG. 7, each rectangular block having rounded corners represents a process by the user side who has acquired the disc type recording medium 10 by free distribution while each rectangular block having right-angled corners represents a process by the server side of the record company or the like.

Further, in the present example, UID0 represents a UID for contents for promotion, and UID1 to UIDN represent UIDs for contents for a normal version.

It is to be noted that FIG. 7 illustrates a particular procedure where digital data of individual contents and UIDs added for the individual data are all encrypted and the user side acquires a key for decryption from the server 33 side of a homepage indicated by a URL.

Referring to FIG. 7, the user would load the disc type recording medium 10 to which the present invention is applied into the UID reproduction optical disk player 31 at step S11. Then, at step S12, data relating to a URL, which is a network address of a homepage of the server, in the UIDs recorded on the disc type recording medium 10 is read out.

Then at step S13, accessing to the homepage is tried, and the home page is accessed at step S31 on the server 33 side. The server 33 side issues a request for the user name at step S32. In response to the request, the user side wound input the user name at step S14.

The inputted user name is sent to the server 33 side, and at step S33, the user name is stored (registered) into the server. Then at step S34, the server 33 side issues a request for transmission of UID data recorded on the disc type recording medium 10.

The user side reads out the UID0 data from the disc type recording medium 10 and transmits the UID0 data to the server 33 at step S15. The server 33 authenticates and stores the UID data transmitted thereto from the user side at step S35, and then discriminates whether or not the authentication is OK at step S36. If a result of the authentication is NO, then the server 33 inhibits the accessing of the user side to the homepage and causes a display unit of the personal computer of the user to display an error message at step S16. Further, the server side records a communication history TR (transaction) at step S37 and ends the communication.

On the other hand, if it is discriminated at step S36 that the UID0 data is authenticated successfully, then the server 33 side produces and transmits a decryption key for the UID0 to the user side and presents various services relating to the UID to the user side at step S38.

The services relating to the UID include, for example, distribution of a lottery ticket or a discount coupon for a concert ticket of the player of literary work data, free preview of a network live program of the player and so forth. It is to be noted that, at step S38, in order to find the number of times by which the UID0 data, that is, the data for promotion, is utilized, the number of times is counted.

Then, at step S17, the user side decodes the contents of the UID with the decryption key and reproduces the contents (listen to the CD for promotion which introduces the contents for a normal version managed with the UIDs UID1 to UIDN), and selects and transmits one of the various presented services to the server side.

Then at step S18, the user would determine whether or not the contents for a normal version should be purchased. If the contents for a normal version should not be purchased, then the processing returns to step S13. However, if the contents for a normal version should be purchased, then the user would select any of the contents for a normal version at step S19 and transmit the UID UIDi of the contents to the server side.

The server side recognizes the selected service and provides the service at step S39. Then, the server side authenticates the UIDi transmitted thereto from the user side at step S40. Then, if it is discriminated at step S41 that the UIDi is not authenticated successfully, then the server 33 inhibits the accessing of the user side to the homepage and causes the display unit of the personal computer of the user to display an error message at step S20. Further, the server 33 side records a communication history TR (transaction) at step S42 and ends the communication.

If it is discriminated at step S41 that the authentication is OK, then the server 33 advances its processing to step S43, at which it issues, for example, a charging request for decryption and presents, for example, various services relating to the selected UIDi (distribution of a concert ticket of the player of the literary work data, an invitation ticket of a movie theater or the like) to the user. Then, the user would select whether or not the charging is acknowledged at step S21.

If the user rejects the charging at step S21, then the user would issue a notification that the charging is rejected to the server 33 of the homepage. The server 33 side thus records a communication history TR at step S44 and ends the communication. On the other hand, the processing on the user side returns to step S13.

If the user selects charging OK at step S21, then the user would select one of the services presented at step S43. Then, the server side performs the charging process at step S45 and produces and transmits decryption key data KID to the personal computer side of the user and then provides the selected service at step S46. Thereafter, the server 33 side records a communication history TR at step S47 and ends the communication.

Here, the decryption key data KID is preferably produced by encoding or encrypting key data K for decrypting digital data corresponding to encrypted literary work data with a serial number of the disc type recording medium 10 included in the UID data or the like so that, even if the decryption key data KID is stolen, it cannot be used without the UID data.

Then, the personal computer side of the user decodes or decrypts the decryption key data KID with the UID data to acquire the key data K for data decryption. Then at next step S24, the personal computer side uses the key data K to decode or decrypt data corresponding to the encrypted literary work data at step S24 and then reproduces the digital data at step S25.

As described above, according to the embodiment described above, since a communication history (TR) upon counting of the number of times of utilization of UID data, upon authentication of UID data or upon discrimination of whether or not charging is OK is recorded, utilization situations of contents for promotion and data for different applications of contents for a normal version can be grasped with certainty by the server 33 side, that is, for example, by a record company.

For example, at step S38 of FIG. 7, the number of times of utilization of data of the UID0, that is, of data of the contents for promotion, is found. At step S44, the number of times by which, although the contents data for promotion is utilized, contents data for a normal version is not purchased is found. At step S47, the number of times by which contents data for a normal version is purchased is found.

After a request for transmission of the UID is issued from the server 33 to the user side at step S34 of FIG. 7, UID data may not be transmitted one by one, but a plurality of, for example, all UID data may be transmitted so that, after they are authenticated successfully, the user side can select any of the contents data for a normal version from the beginning.

In particular, the processes described hereinabove may be modified such that the user side transmits all UIDs UID0 to UIDN at step S15 and the server 33 side authenticates each of the UIDs UID0 to UIDN at steps S35 to S39 and then the user side discriminates whether or not the contents data should be purchased at steps S16 to S18.

Further, the contents data for promotion may not otherwise be encrypted so that they can be reproduced from the beginning by the user without the necessity for authentication of the UID0.

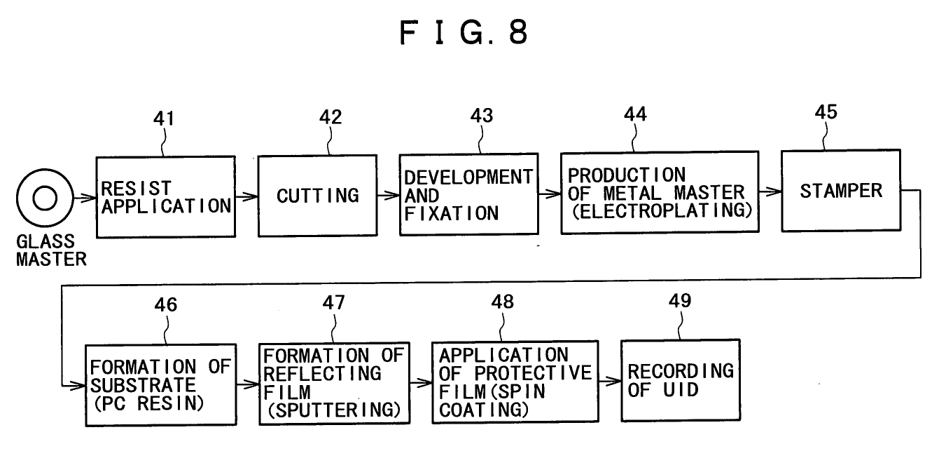

A process of manufacturing a disc to which such UID data as described above are added is described with reference to FIG. 8. At a resist application step 41, photoresist is applied to a glass master disc. At a next cutting step 42, a concave and convex pit pattern in accordance with data to be reproduced is cut to produce a master disc.

The master disc on which the pit pattern is laser cut is developed and fixed at a development and fixation step 43, and is subject to electroplating on the surface thereof at a metal master disc production step 44 to produce a metal master disc which is a mother disc. Then, a stamper is produced based on the metal master disc at a stamper formation step 45, and then at a substrate formation step 46, the stamper is used to produce a disc substrate of a transparent resin such as a polycarbonate (PC) resin or an acrylic resin.

The disc substrate produced here has the pit pattern, which was formed on the master disc at the cutting step described hereinabove, transferred thereto. A reflection film is formed by sputtering, at a next reflection film formation step 47, on the surface of the disc substrate on which the pit pattern is formed.

The UID data according to the present invention is recorded utilizing the reflection film formed on the disc type recording medium 10.

Here, the reflection film used for the disc type recording medium according to the present invention is formed using a material which allows recording of data in order to make it possible to record the UID data on the reflection film at a later step. Further, it is necessary for the reflection film to be formed from a material which allows optical reading of the UID data recorded thereon.

Therefore, the reflection film formed on the disc type recording medium according to the present invention is formed from a material whose reflection factor is substantially equal to that of a reflection film of a CD or a DVD or a reflection factor which allows reading out by means of an optical head used conventionally but is varied, by thermal recording using a laser beam, with respect to a light beam such as a laser beam for reading out.

In particular, the reflection film is formed from a metal film which indicates a characteristic that the reflection factor with respect to a light beam for reading out varies within a range substantially from 0.5% to 10% by thermal recording. More particularly, the reflection film is formed from an Al alloy film of Al100-xXx which is a metal film containing Al as a principal component or an Ag alloy film of Ag100-xXx which is a metal film containing Ag as a principal component.

On the reflection film formed on the disc substrate, an ultraviolet curing resin is applied by spin coating and ultraviolet rays are illuminated to form a protective film at a next protective film application step 48. Thereafter, at a UID recording step 49, a laser beam is irradiated on the reflection film to modulate the reflection factor of the reflection film thereby to record the UIDs by thermal recording.

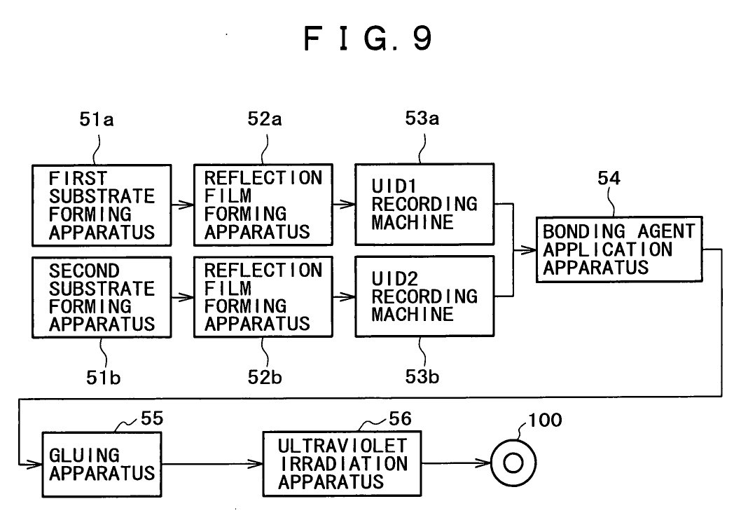

Now, an apparatus for recording the UID of the present invention on a data recording medium formed from two disc type recording media adhered to each other like a two-layer DVD or a SACD is described with reference to FIG. 9.

The apparatus shown includes first and second substrate forming apparatus 5la and 51b each of which performs, for example, the resist application step 41, cutting step 42, development and fixation step 43, metal master disc production step 44 and stamper formation step 45 described hereinabove with reference to FIG. 8 to form a substrate.

On the first substrate formed by the first substrate forming apparatus 51a, a reflection film is formed, for example, by a reflection film forming apparatus 52a which uses sputtering as described hereinabove with reference to FIG. 9, and then the UID1 is recorded, for example, by a UID1 recording machine 53a which performs thermal recording by irradiation of a laser beam described hereinabove with reference to FIG. 8.

Similarly, on the second substrate formed by the second substrate forming apparatus 51b, a reflection film is formed, for example, by a reflection film forming apparatus 52b which uses sputtering as described hereinabove with reference to FIG. 8, and then the UID2 is recorded, for example, by a UID2 recording machine 53b which performs thermal recording by irradiation of a laser beam described hereinabove with reference to FIG. 8.

Then, bonding agent is applied to the first substrate, on which the UID1 is recorded and the second substrate on which the UID2 is recorded, by a bonding agent application apparatus 54, and the first and second substrates are adhered to each other by a gluing apparatus 55. Thereafter, ultraviolet rays are irradiated on the first and second substrates by an ultraviolet irradiation apparatus (UV hardening apparatus) 56 to cause the bonding agent to cure thereby to complete a laminated disc 100.

The UID1 and UID2 may not be recorded in parallel before two substrates each having a reflection film formed thereon are adhered to each other as described above, but they may otherwise be recorded individually on two substrates at a final stage after the two substrates are adhered to each other as seen in FIG. 10. It is to be noted that the same portions of FIGS. 10 and 9 denote the same reference numerals.

Now, a particular example wherein the UID of the present invention is recorded on a data recording medium formed by adhering two substrates each having a recording layer provided on one of the opposite faces thereof such that the recording layer of one of the substrates and the other substrate are adhered to each other.

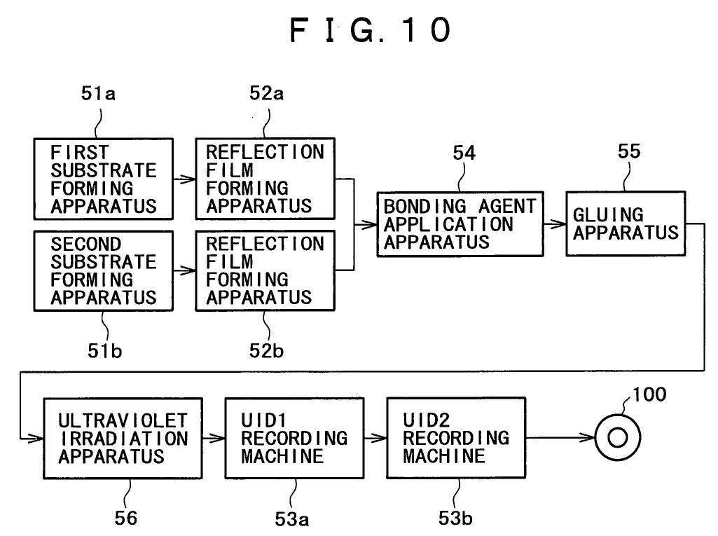

FIG. 11 shows an example of an optical recording medium 60 of the SACD type. Referring to FIG. 11, a reflection film 62 on which, for example, the UID 1 is recorded is formed on one surface of a first substrate 61, and a protective film 63 is formed on the reflection film 62.

A moisture proof film 64 is formed on the other surface of the first substrate 61. A semitransparent reflection film 66 on which, for example, the UID2 is recorded is formed on one surface of a second substrate 65, and a moisture proof film 67 is formed on the other surface of the second substrate 65. The moisture proof film 64 and the semitransparent reflection film 66 are adhered to each other by an adhesive layer 68.

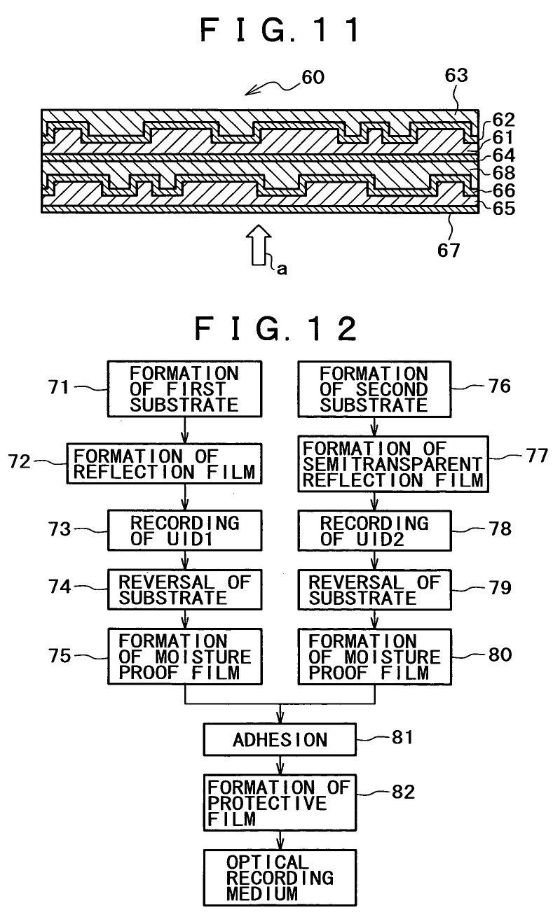

Now, a process of manufacturing the optical recording medium 60 of FIG. 11 is described with reference to FIG. 12. First, at a first substrate molding step 71, a first substrate is molded by injection molding of light transmittance resin. At a reflection film forming step 72, a reflection film is formed on the first substrate.

At a UID1 recording step 73, for example, thermal recording by laser beam irradiation described hereinabove with reference to FIG. 8 is performed to record the UID1. At a substrate reversing step 74, the first substrate having the reflection film formed on the one surface thereof is reversed in the sputtering apparatus.

At a moisture proof film forming step 75, a moisture proof film is formed on the other surface of the first substrate. At a second substrate molding step 76, a second substrate is molded by injection molding similarly as at the first substrate molding step 71. At a semitransparent reflection film forming step 77, a semitransparent reflection film is formed on the second substrate.

At a UID2 recording step 78, for example, thermal recording by laser beam irradiation described hereinabove with reference to FIG. 8 is performed to record the UID2. At a substrate reversing step 79, the second substrate having the reflection film form on the one surface is reversed in the sputtering apparatus.

At a moisture proof film forming step 80, a moisture film is formed on the other surface of the second substrate. At an adhesion step 81, the first substrate and the second substrate are adhered to each other. At a protective film forming step 82, a protective film is formed on the reflection film of the first substrate. The optical recording medium 60 of FIG. 11 is completed thereby.

It is to be noted that the number of UIDs to be recorded on the reflection film of each substrate is not limited to one but may be a plural number.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A data recording medium on which digital data is recorded,
that data recording medium comprising a plurality of pieces of identification information, that relate individually to digital data used for a plurality of different applications, recorded in advance thereon.

2. The data recording medium according to claim 1, wherein the plurality of pieces of identification information include
first identification information relating to digital data used for a first application and
second identification information relating to digital data used for a second application.

3. The data recording medium according to claim 2, wherein the second identification information includes a plurality of pieces of identification information individually relating to digital data based on a plurality of contents.

4. The data recording medium according to claim 1, wherein the digital data is limited in reproduction allowing regions individually for the plurality of pieces of identification information.

5. The data recording medium according to claim 2, wherein at least the second identification information from between the first identification information and the second identification information is in an encrypted state and is decrypted with data relating to a key for decipherment of the encrypted identification information inputted from outside.

6. The data recording medium according to claim 2, wherein the first application relates to digital data for promotion and the second application relates to digital data for a normal version.

7. The data recording medium according to claim 1, wherein the plurality of pieces of identification information are recorded in a data recording region in which the digital data is recorded and/or a lead-in region provided on the inner circumference side with respect to the data recording region.

8. The data recording medium according to claim 1, wherein the plurality of pieces of identification information are recorded in a data recording region in which the digital data is recorded.

9. The data recording medium according to claim 1, wherein the recording medium comprises a plurality of recording layers layered on one surface of a substrate.

10. The data recording medium according to claim 1, wherein the data recording medium comprises two substrates each having a recording layer provided on one surface thereof and adhered to each other at the recording layers thereof.

11. The data recording medium according to claim 1, wherein the data recording medium comprises two substrates each having a recording layer provided on one surface thereof, wherein the recording layer of one of the substrates is adhered to the other substrate.

12. The data recording medium according to claim 1, wherein the data recording medium is an optical disk.

13. A data recording apparatus for recording digital data on a data recording medium, wherein the data recording apparatus records, upon manufacture of a data recording medium, a plurality of pieces of identification information individually relating to digital data to be used for a plurality of different applications on the data recording medium.

14. The data recording apparatus according to claim 13, wherein the data recording apparatus records the plurality of pieces of identification information such that the plurality of pieces of identification information individually restrict reproduction allowing regions of the digital data.

15. The data recording apparatus according to claim 13, wherein the data recording apparatus records at least one of the plurality of pieces of identification information in an encrypted state.

16. The data recording apparatus according to claim 13, wherein the recording apparatus records the plurality of pieces of identification information in a data recording region of the data recording medium in which the digital data is recorded and/or a lead-in region provided on the inner circumference side with respect to the data recording region.

17. The data recording apparatus according to claim 13, wherein the recording apparatus records the plurality of pieces of identification information in a data recording region of the data recording medium in which the digital data is recorded.

18. The data recording apparatus according to claim 13, wherein the data recording apparatus records the plurality of pieces of identification information on a plurality of recording layers layered on one surface of a substrate.

19. The data recording apparatus according to claim 13, wherein the recording apparatus records the plurality of pieces of identification information on recording layers each provided on one surface of one of two substrates which are adhered to each other at the recording layers thereof.

20. The data recording apparatus according to claim 13, wherein the recording apparatus records the plurality of pieces of identification information on recording layers each provided on one surface of one of two substrates, the recording layer of one of the substrates being adhered to the other substrate.

21. The data recording apparatus according to claim 13, wherein the recording apparatus records the plurality of pieces of identification information on a recording layer of an optical disk.

22. A data recording method for recording digital data on a data recording medium, comprising recording, upon manufacture of a data recording medium, a plurality of pieces of identification information individually relating to digital data to be used for a plurality of different applications on the data recording medium.

23. The data recording method according to claim 22, wherein the plurality of pieces of identification information are recorded in such a manner as to individually restrict reproduction allowing regions of the digital data.

24. The data recording method according to claim 22, wherein at least one of the plurality of pieces of identification information is recorded in an encrypted state.

25. The data recording method according to claim 22, wherein the plurality of pieces of identification information are recorded continuously.

26. The data recording method according to claim 22, wherein the plurality of pieces of identification information are recorded intermittently.

27. The data recording method according to claim 22, wherein the plurality of pieces of identification information are recorded on a plurality of data recording media before the plurality of data recording media are adhered to each other.

28. The data recording method according to claim 22, wherein the plurality of pieces of identification information are recorded on a plurality of data recording media after the plurality of data recording media are adhered to each other.

29. A data reproduction method for reproducing a recording medium on which digital data to be used for a first application and first identification information relating to the digital data as well as digital data to be used for a second application and second identification information relating to the digital data for the second application are recorded, the data reproduction method comprising:
discriminating whether or not identification information is recorded on the recording medium;
discriminating whether the recorded identification information is the first identification information or the second identification information when the identification information is recorded on the recording medium; and
reproducing the digital data relating to the first identification information when it is discriminated that the recorded identification information is the first identification information, but
decrypting the digital data relating to the second identification information based on data relating to a key for decryption of the digital data acquired from outside and reproducing the decrypted digital data when it is discriminated that the recorded identification information is the second identification information.

30. A data transmission apparatus, comprising:
a terminal section for reproducing a recording medium on which digital data to be used for a first application and first identification information relating to the digital data as well as digital data to be used for a second application and second identification information relating to the digital data for the second application is recorded; and
a server section connected to said terminal section through a communication line for managing the recording medium;
the server section being operable to discriminate, when the first identification information is received from said terminal section, the received first identification information and permit, when it is discriminated that the first identification information is identification information managed by said server section, a procedure for decoding the digital data relating to the second identification information.

31. The data transmission apparatus according to claim 30, wherein, when the server section receives a request for decoding of the digital data relating to the second identification information from the terminal section, the server section issues a demand to perform a charging process to said terminal section.

32. The data transmission apparatus according to claim 31, wherein, when the charging process is performed by the terminal section, the server section transmits data relating to a key for decryption of the digital data relating to the second identification information to said terminal section.

33. The data transmission apparatus according to claim 30, wherein, when it is discriminated that the first identification information is identification information managed by said server section, the sever section provides a predetermined service to said terminal section.

34. The data transmission apparatus according to claim 32, wherein, when the charging process is performed by the terminal section, the server section provides a predetermined service to the terminal section.

35. The data transmission apparatus according to claim 30, wherein the server section counts a number of times by which the first identification information is inputted thereto through the communication line.

36. The data transmission apparatus according to claim 32, wherein the server section counts the number of times by which the charging process is performed by said terminal section.
